(19) United States
(12) Patent Application Publication
(10) Pub. No.: US 2018/0175493 A1
(43) Pub. Date: Jun. 21, 2018

(54) ANTENNA DEVICE AND ELECTRONIC DEVICE USING THE SAME

(71) Applicants: NANNING FUGUI PRECISION INDUSTRIAL CO., LTD., Nanning (CN); HON HAI PRECISION INDUSTRY CO., LTD., New Taipei (TW)

(72) Inventors: Chih-Chieh YANG, New Taipei (TW); Yi-Hao CHANG, New Taipei (TW)

(21) Appl. No.: 15/379,728

(22) Filed: Dec. 15, 2016

(51) Int. Cl. H01Q 1/38; H01Q 5/314; H01Q 9/04; H01Q 1/48; H01Q 1/24

(52) U.S. Cl. CPC H01Q 1/38; H01Q 5/314; H01Q 1/243; H01Q 1/48; H01Q 9/0421

(57) ABSTRACT

A Planar Inverted-F antenna (PIFA) device includes a circuit board having a first surface, a second surface, and a through hole, an antenna being disposed in the first surface, and a metal member being disposed in the second surface. The through hole is connected between the first surface and the second surface. The antenna couples with the metal member to have a specific capacitive coupling effect through the through hole to enable transmission and reception of specific wireless frequencies by an electronic device having the PIFA.

### FIELD

The subject matter herein generally relates to antenna devices.

### BACKGROUND

It is difficult to decrease the size of a PIFA (Planar Inverted-F Antennas) module, while accommodating the need for a large frequency range, because the antennas occupy large spaces on a system board.

### BRIEF DESCRIPTION OF THE DRAWINGS

Implementations of the present technology will now be described, by way of example only, with reference to the attached figures.

FIG. 1 is a schematic diagram of an exemplary embodiment of an electronic device with an antenna device of the present disclosure.

FIG. 2 is a schematic diagram of the antenna device of FIG. 1.

FIG. 3 illustrates an equivalent circuit of a capacitive coupling between an antenna and a metal member of the antenna device of FIG. 1.

FIG. 4 is a diagram of resonant frequencies excited by the antenna device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

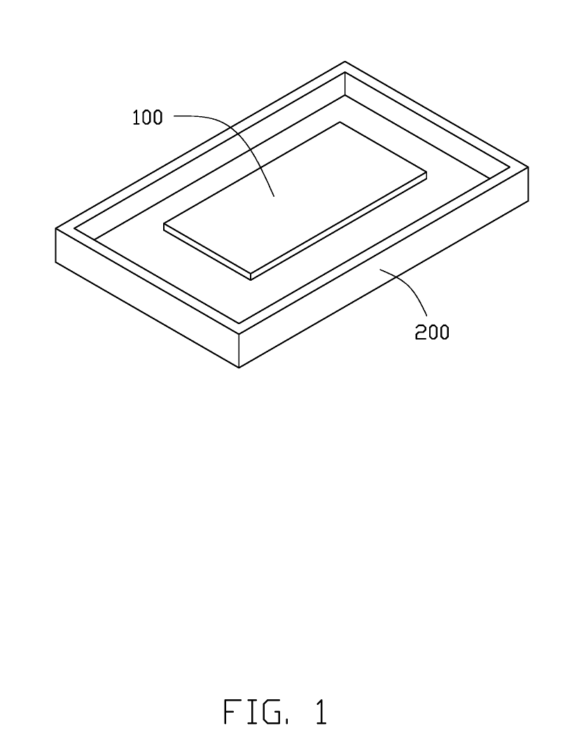

FIG. 1 illustrates an antenna device 100 of an embodiment of the present disclosure.

The antenna device 100 is mounted in a housing 200 of an electronic device to transmit and receive wireless signals. In at least one exemplary embodiment, the electronic device is a mobile phone.

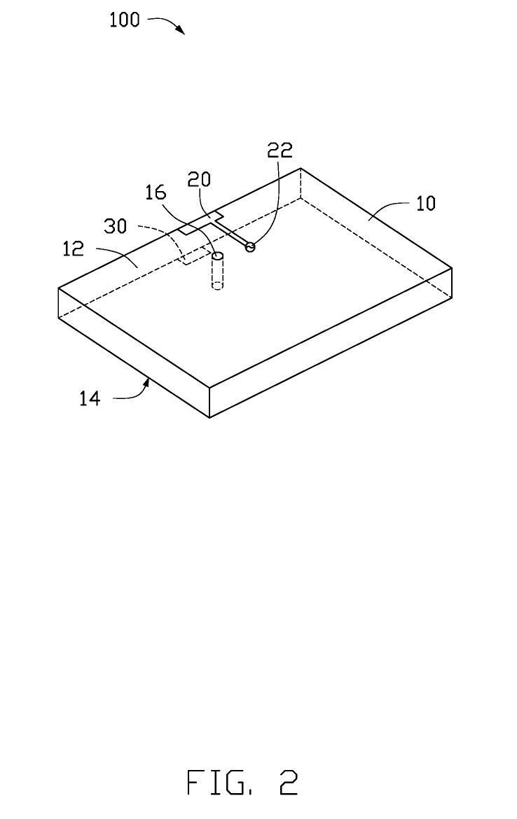

FIG. 2 illustrates that the antenna device 100 comprises a circuit board 10, an antenna 20, and a metal member 30.

The circuit board 10 also comprises a first surface 12, a second surface 14, and a through hole 16.

The first surface 12 is opposite to the second surface 14. The first surface 12 is parallel to the second surface 14.

The antenna 20 is disposed on the first surface 12 of the circuit board 10 and the metal member 30 is disposed on the second surface 14 of the circuit board 10. In at least one embodiment, the antenna 20 is parallel to the metal member 30 in the transverse direction.

The through hole 16 is connected between the first surface 12 and the second surface 14. The antenna 20 is capacitively coupled to the metal member 30 through the through hole 16. In an exemplary implementation, the through hole 16 is filled with air. In another exemplary implementation, the through hole 16 is filled with other dielectric material. The antenna 20 may transmit or receive signals through the through hole 16.

In at least one exemplary embodiment, the length of the circuit board 10 is about 90 mm and the width of the circuit board 10 is about 50 mm.

In at least one exemplary embodiment, the height of the circuit board 10 is about 0.4 mm. The dielectric constant of the circuit board 10 is about 4.4.

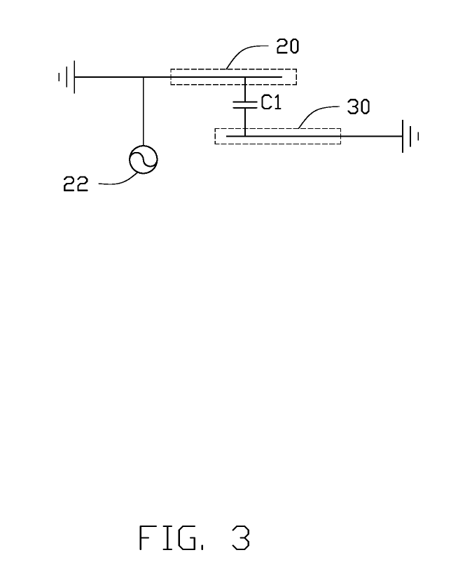

FIG. 3 illustrates an equivalent circuit of a capacitive coupling between the antenna 20 and the metal member 30.

As FIG. 3 shows, a first terminal of the antenna 20 is electrically coupled to ground after being electrically coupled to a signal source 22.

A second terminal of the antenna 20 is electrically coupled to a first terminal of the metal member 30 through a capacitor C1. A second terminal of the metal member 30 is electrically coupled to ground.

The grounding direction of the first terminal of the antenna 20 is parallel but opposite to the grounding direction of the second terminal of the metal member 30.

The resonance frequency of the antenna 20 changes as the capacitance value of the capacitor C1 changes. The resonance frequency of the antenna 20 maintains an inverse proportional relationship with the capacitance value of the capacitor C1.

The relationship between the capacitance value C of the capacitor C1, the dielectric constant E of the circuit board 10, a coupling area A of the antenna 20, and a distance D between the antenna 20 and the metal member 30, is:

C=ε×A/d.

If the distance between the antenna 20 and the metal member 30 changes, the capacitance value of the capacitor C1 changes accordingly.

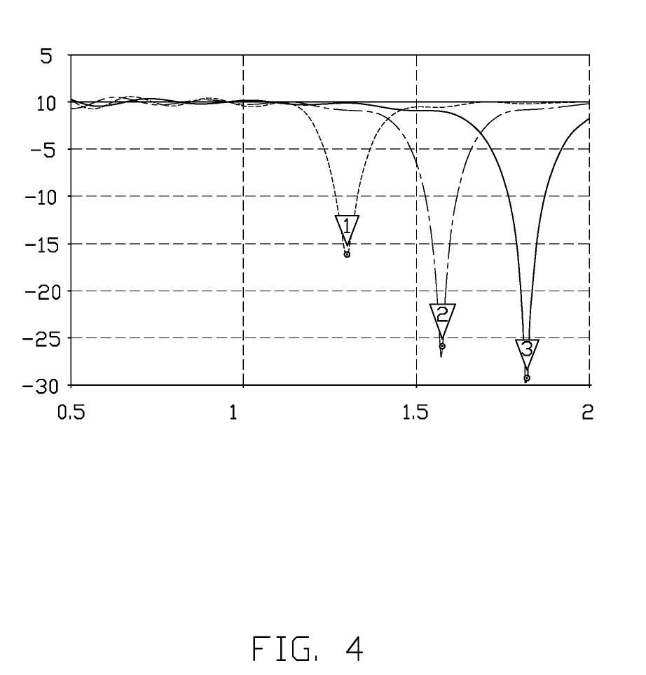

FIG. 4 illustrates that when the capacitance value C of the capacitor C1 is adjusted, the antenna 20 is given a number of different resonant frequencies. The resonant frequency of the antenna 20 changes following a change in the capacitance value of the capacitor C1.

In at least one embodiment, the resonant frequency of the antenna 20 covers a range between 1.3 GHz to 1.82 GHz.

For example, a specific resonant frequency of the antenna 20 can be designed to be 1.575 GHz, to apply to the frequency of the GPS (Global Positioning System) standard.

The embodiments shown and described above are only examples. Many details are often found in the art such as the other features of antenna device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna device comprising:
a circuit board comprising a first surface, a second surface, and a through hole, the first surface being opposite to the second surface, wherein the through hole connected between the first surface and the second surface;
an antenna disposed on the first surface; and
a metal member disposed on the second surface;
wherein the antenna is capacitively coupled to the metal member through the through hole.

2. The antenna device of claim 1, wherein the first surface is parallel to the second surface, and the antenna is parallel to the metal member in the transverse direction.

3. The antenna device of claim 2, wherein a first terminal of the antenna is grounded, the first terminal of the antenna is electrically coupled to a signal source, a second terminal of the antenna is electrically coupled to a first terminal of the metal member through a capacitor, and a second terminal of the metal member is grounded.

4. The cleaning device of claim 3, wherein a length of the circuit board is about 90 mm.

5. The cleaning device of claim 4, wherein a height of the circuit board is about 0.4 mm.

6. The cleaning device of claim 5, wherein a width of the circuit board is about 50 mm.

7. The cleaning device of claim 6, wherein a dielectric constant of the circuit board is about 4.4.

8. An antenna device comprising:
a circuit board comprising a first surface, a second surface, and a through hole, the first surface being opposite to the second surface, wherein the through hole connected between the first surface and the second surface;
an antenna disposed on the first surface; and
a metal member disposed on the second surface;
wherein the first surface is parallel to the second surface, and the antenna is parallel to the metal member in the transverse direction; wherein the antenna is capacitively coupled to the metal member through the through hole.

9. The antenna device of claim 8, wherein a first terminal of the antenna is grounded, the first terminal of the antenna is electrically coupled to a signal source, a second terminal of the antenna is electrically coupled to a first terminal of the metal member through a capacitor, and a second terminal of the metal member is grounded.

10. The cleaning device of claim 9, wherein a length of the circuit board is about 90 mm.

11. The cleaning device of claim 10, wherein a height of the circuit board is about 0.4 mm.

12. The cleaning device of claim 11, wherein a width of the circuit board is about 50 mm.

13. The cleaning device of claim 12, wherein a dielectric constant of the circuit board is about 4.4.

14. An electronic device comprising an antenna device and a housing, the antenna device disposed in the housing, the antenna device comprising:
a circuit board comprising a first surface, a second surface, and a through hole, the first surface being opposite to the second surface, wherein the through hole connected between the first surface and the second surface;
an antenna disposed on the first surface; and
a metal member disposed on the second surface;
wherein the first surface is parallel to the second surface, and the antenna is parallel to the metal member in the transverse direction;
wherein the antenna is capacitively coupled to the metal member through the through hole.

15. The electronic device of claim 14, wherein a first terminal of the antenna is grounded, the first terminal of the antenna is electrically coupled to a signal source, a second terminal of the antenna is electrically coupled to a first terminal of the metal member through a capacitor, and a second terminal of the metal member is grounded.

16. The electronic device of claim 15, wherein a length of the circuit board is about 90 mm.

17. The electronic device of claim 16, wherein a height of the circuit board is about 0.4 mm.

18. The electronic device of claim 17, wherein a width of the circuit board is about 50 mm.

19. The electronic device of claim 18, wherein a dielectric constant of the circuit board is about 4.4.
